(19) United States
(12) Patent Application Publication
(10) Pub. No.: US 2013/0119762 A1
(43) Pub. Date: May 16, 2013

(54) LOAD-SEGMENTATION-BASED FULL BRIDGE INVERTER AND METHOD FOR CONTROLLING SAME

(71) Applicants: Seong Jeub Jeon, Busan (KR); Dong Ho Cho, Seoul (KR); Chun Taek Rim, Daejeon (KR); Gu Ho Jeong, Seoul (KR)

(72) Inventors: Seong Jeub Jeon, Busan (KR); Dong Ho Cho, Seoul (KR); Chun Taek Rim, Daejeon (KR); Gu Ho Jeong, Seoul (KR)

(21) Appl. No.: 13/518,213

(22) PCT Filed: Dec. 23, 2009
(86) PCT No.: PCT/KR09/07695

§ 371 Date: Jan. 29, 2013

(51) Int. Cl. H02M 7/5387

(52) U.S. Cl. CPC H02M 7/53871
USPC 307/38

(57) ABSTRACT

Disclosed are a full bridge inverter and method for controlling same. The full bridge converter according to the present invention comprises: a plurality of first switches connected at one end thereof to a positive terminal for a direct current (DC) input voltage; a plurality of second switches connected at one end thereof to a negative terminal for a DC input voltage; and a plurality of loads connected at connection terminals formed by one-on-one connections of the opposite ends of each first switch to the opposite ends of each second switch. Thus, in cases requiring the selective application of voltages converted from DC to AC to the plurality of loads, the number of semiconductor devices can be minimized to reduce costs, and a reduction in load current can be prevented.

### TECHNICAL FIELD

The preferred embodiment of the present invention relates to a load-segmentation-based full bridge inverter and method for controlling same, more specifically, relates to a full bridge inverter and method for controlling same in cases requiring the selective application of voltages converted from DC to AC to the plurality of loads, wherein the number of semiconductor devices can be minimized to reduce costs, and a reduction in load current can be prevented.

### BACKGROUND OF TECHNOLOGY

As a device that converts direct current to alternating current, an inverter traditionally uses mainly thyratron, a mercury rectifier, etc., and with the exception of DC transmission-type mass storage circuits, the majority of general-use inverters substitute with thyristor.

Generally, inverters are classified as either single-phase or three-phase inverters. Among these, the single-phase inverter can supply alternating current to a single load. However, in the case of an online electric vehicle, etc., the electric instrument, that is comprised of a number of loads requiring alternating current supply, and the installation of such a single-phase inverter that responds to each load, is the main cause of increasing the construction cost of said electric instrument.

Accordingly, as depicted in FIG. 1, a bi-directional semiconductor-like connective switch is installed that responds to each load and mainly uses a method of selective current application to each load with the ON/OFF control of the installed connective switch.

However, a connective switch has a two-switch formation where each can switch the other to the opposite direction, as depicted in FIG. 1, in the hypothetical case where a connective switch is installed that handles 4 loads, there are a total of 12 semiconductor devices installed in the full bridge inverter. In such cases where the number of semiconductor devices increases, not only is there the reduction in load current, but it also is the cause of increasing the cost of the full bridge inverter.

### DETAILED DESCRIPTION OF PREFERRED EMBODIMENTS

### Technical Challenge

The invention is devised in order to solve the issue, and had the purpose of providing a full bridge inverter and method for controlling same with increased efficiency by reducing the number of devices that a load current passes through, and minimizing the cost of semiconductor switch devices, in cases where power is supplied successively to a plurality of segments via an inverter, wherein a connective switch is lacking, a segment can be selected by the TURN ON/OFF control of a semiconductor switch alone.

### Means of Resolution

In order to accomplish this strategic purpose, and according to the preferred embodiment of the present invention, the full bridge inverter comprises: a plurality of first switches connected at one end thereof to a positive terminal for a direct current (DC) input voltage; a plurality of second switches connected at one end thereof to a negative terminal for a DC input voltage; and a plurality of loads connected at connection terminals formed by one-on-one connections of the opposite ends of each first switch to the opposite ends of each second switch.

These first and second switches are comprised of a parallel-connected structure wherein each is formed with a transistor, diode and capacitor.

Also, in the full bridge inverter it is desirable that the full bridge inverter be comprised of a controller that regulates with regard to the first and second switches ON/OFF.

At this time, in the controller, it is desirable that the second switch, connected to the turned-on first switch, maintain the TURN OFF state, in cases where the TURN ON state is maintained by at least one first switch among a plurality of turned-on first switches.

Also, with regard to the controller, it is desirable that the first switch connected to the turned-on second switch, maintains the TURN OFF state, in cases where the TURN ON state is maintained by at least one second switch among a plurality of second switches.

Also, it is desirable that the controller regulate the second switch, connected at both ends of a load thereof, to turn on before a given time, in cases where the first switch, which is connected to one particular load among a plurality of loads, is turned on.

Also, it is desirable that the controller regulate the second switch, connected at both ends of a load thereof, to turn on after a given time, in cases where the first switch, which is connected to one particular load among a plurality of loads thereof, is turned on.

Also, it is desirable that the controller regulate the second switch, connected at one end of a load, to turn on after a given time in cases where the first switch, connected to the second switch is connected at both ends of a load thereof; and the second switch, which is connected at both ends of a load thereof, to turn on before a given time, in cases where the first switch, connected at one end of a load among a plurality of loads is turned on.

In order to accomplish this strategic purpose, and according to the preferred embodiment of the present invention, the full bridge inverter and method for controlling, is comprised of: a plurality of first switches connected at one end thereof to a positive terminal for a direct current (DC) input voltage; a plurality of second switches connected at one end thereof to a negative terminal for a DC input voltage; and a plurality of loads connected at connection terminals formed by one-on-one connections of the opposite ends of each first switch to the opposite ends of each second switch; which is comprised of the following steps: the step wherein one at least one first switch among a plurality of first switches turns on; and

the step wherein the second switch, connected to the turned-on first switch thereof maintains the TURN OFF state, while the turned-on first switch, maintains the TURN ON state.

Preferably, the strategic method for controlling the full bridge inverter, is comprised of the following steps: the step where the turned-on first switch is turned off; the step wherein at least one second switch among a plurality of second switches is turned on; and the step wherein the first switch, connected to the turned-on second switch maintains the TURN OFF state, while the turned-on second switch, maintains the TURN ON state.

Also, the strategic method for controlling the full bridge inverter, also is comprised of the following step wherein the second switch connected to both ends of a load connected to one end of a turned-on first switch among a plurality of loads, is turned on after a given time compared to the turned-on first switch.

Also, the strategic method for controlling the full bridge inverter, may also comprise the further step wherein the second switch connected at both ends of a load thereof connected to one end of a turned-on first switch among a plurality of loads, is turned on before a given time compared to the turning on first switch.

Also, the strategic method for controlling the full bridge inverter, may also comprise the further steps:

the step wherein a second switch connected at both ends of a load thereof connected at one end of a turned-on first switch, among a plurality of loads is turned on after a given time compared to the turned-on first switch;
the step wherein a turned-on first switch is turned off;
the step wherein a turned-on second switch is turned off; and
the step wherein a first switch connected to a second switch thereof is turned on.

Also, the strategic method for controlling the full bridge inverter, may comprise the further step wherein a second switch connected at one end of a load thereof, is turned on before a given time, compared to the turning on first switch.

Also, the strategic method for controlling the full bridge inverter, may comprise the further steps: the step wherein a load is selected in order receive current supply; and, the step wherein the second switch connected to both ends of a selected load thereof is turned on before a given time compared to the turning on first switch, once the first switch connected to one end of a selected load thereof is turned on.

### Efficiency of Preferred Embodiment

According to the preferred embodiment of the present invention, increased efficiency by reducing the number of devices that a load current passes through, minimizing the cost of semiconductor switch devices. In cases where power is supplied successively to a plurality of segments via an inverter, wherein a connective switch is lacking, a segment can be selected by the TURN ON/OFF control of a semiconductor switch alone.

### SIMPLE EXPLANATION OF FIGURES

FIG. 1 portrays one example of a full bridge inverter wherein a load is formed from a number of segments.

FIG. 2 portrays an example of a full bridge inverter, according to one different preferred embodiment of the present invention.

FIG. 3 portrays an example of a full bridge inverter, according to another preferred embodiment of the present invention.

FIG. 4 portrays an example of the control related to each leg of the switch structure.

FIG. 5 portrays an example of the permitted output voltage to each load.

FIG. 6 roughly portrays an example of the controlling method for full bridge inverter, according to the preferred embodiment of the present invention.

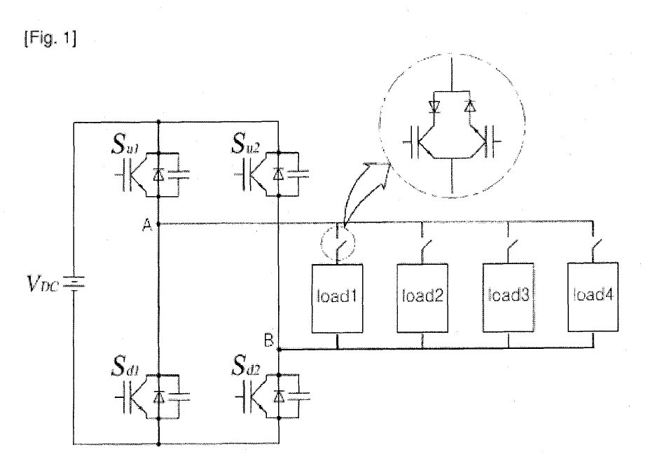

### BEST FORM FOR IMPLEMENTATION OF THE PREFERRED EMBODIMENT

Below, by referring to the figures, in accordance with the preferred embodiment of the present invention, follows a detailed explanation. According to the reference markings of the components of such figures, attention should be given to using the equivalent marking(s), when possible as similar components in the figurative representation are highlighted. Also, according to the explanation of the present invention, a detailed explanation is omitted in the case wherein a concrete explanation regarding notified components and/or functions is determined to be lacking the essentials.

Also, according to the explanation of the components for the present invention, the terminology first, second, A, B, (a), (b), etc. can be used. Such terminology is only distinguishing components from each other, and thus the essentialness, order and/or rank of the above components are not limited due to the above terminology. In such cases where certain components are specified as “connect,” “connected,” and/or “combined with another component, it could mean that a component is directly connected or linked to another, it must be understood that between each component there is a “connect”, “connection”, and/or “combination.”

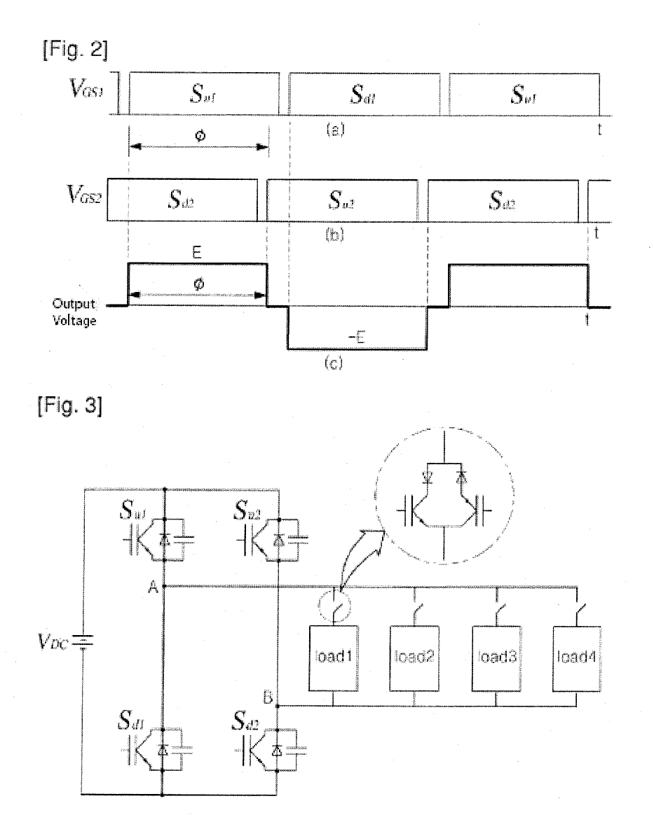

FIG. 2. depicts an outline of a full bridge inverter, according to one preferred embodiment of the present invention. Referring to the figure, the full bridge converter according to the present invention comprises: a plurality of first switches (Su1, Su2, Su3, Su4, Su5) connected at one end to a positive terminal for a direct current (DC) input voltage (VDC); a plurality of second switches (Sd1, Sd2, Sd3, Sd4, Sd5) connected at one end to a negative terminal for a DC input voltage (VDC); and a plurality of loads (load1, load2, load3, load4) connected at connection terminals formed by one-on-one connections of the opposite ends of each first switch (Su1, Su2, Su3, Su4, Su5) to the opposite ends of each second switch (Sd1, Sd2, Sd3, Sd4, Sd5). At this time, the first switch (Su1, Su2, Su3, Su4, Su5) and second switch (Sd1, Sd2, Sd3, Sd4, Sd5) are comprised of a parallel-connected structure wherein each is formed with a transistor, diode and capacitor.

Herein, the one-on-one connected first switch (Su1) and second switch (Sd1) is named leg 1, and the first switch (Su2) and second switch (Sd2) is named leg 2. Also, the first switch (Su3) and second switch (Sd3) is named leg 3, the first switch (Su4) and second switch (Sd4) is named leg 4, and the first switch (Su5) and second switch (Sd5) is named leg 5.

Also, the connection between the first switch (Su1) and second switch (Sd1) of leg 1 is named A1, the connection between the first switch (Su2) and second switch (Sd2) of leg 2 is named A2, the connection between the first switch (Su3) and second switch (Sd3) of leg 3 is named A3, the connection between the first switch (Su4) and second switch (Sd4) of leg 4 is named A4, the connection between the first switch (Su5) and second switch (Sd5) of leg 5 is named A5.

Also, the combining load (load1) connected between leg 1 and leg two is named segment 1, and, the combining load (load2) connected between leg 2 and leg 3 is named segment 2, the combining load (load3) connected between leg 3 and leg 4 is named segment 1, and, the combining load (load4) connected between leg 4 and leg 5 is named segment 4.

Hereinafter, although FIG. 2 depicts a connection between each load (load1, load2, load3, load4) and between each of leg 1 and leg 2, between leg 2 and leg 3, between leg 3 and leg 4, and between leg 4 and leg 5, the position of each load (load1, load2, load3, load4) is not limited to what is depicted. In other words, just as FIG. 3 depicts each load (load1, load2, load3, load4), and a connection could be between leg 1 and leg 2, between leg 1 and leg 3, between leg 1 and leg 4 and between leg 1 and leg 5, and, other diverse combinations are possible. In this case, it is determined that segments are combinations of the first switch and second switch connected to each load thereof of each load standardly.

On one side, the full bridge inverter further is comprised desirably of a controller (410) that controls ON/OFF with regard to each first switch (Su1, Su2, Su3, Su4, Su5) and each second switch (Sd1, Sd2, Sd3, Sd4, Sd5).

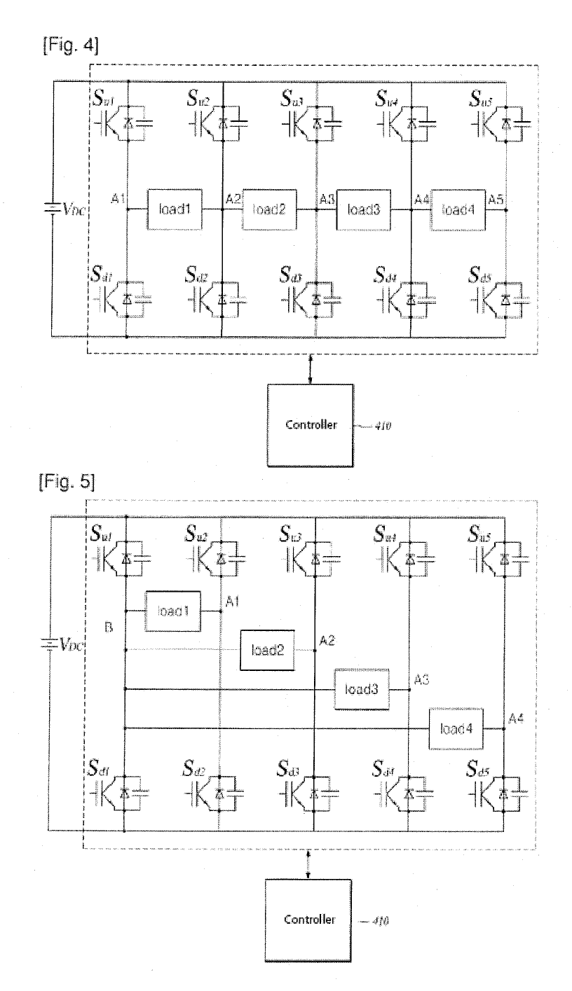

Herein, it is desirable that the controller maintain the first switch, which is connected to the turned-on second switch and on the same leg in the TURN OFF state, in cases where the TURN ON state is maintained by at least one second switch among a plurality of first switches (Su1, Su2, Su3, Su4, Su5). For example, as depicted in FIG. 4, it is desirable that the second switch (Sd1), connected to the turned-on first switch (Su1) and on the same leg 1, maintain the TURN OFF state, in cases where the first switch (Su1) maintains the TURN ON state.

Also, it is desirable that the controller maintain the second switch, which is connected to the turned-on first switch and on the same leg in the TURN OFF state, in cases where the TURN ON state is maintained by at least one first switch among a plurality of first switches (Sd1, Sd2, Sd3, Sd4, Sd5). For example, as depicted in FIG. 4 it is desirable that the first switch (Su1), connected to the turned-on second switch and on the same leg 1, maintain the TURN OFF state, in cases where the first switch (Su1) maintains the TURN ON state.

### Implementation Form of the Preferred Embodiment

FIG. 5 depicts the output voltage wave pattern of free segments due to switch control regarding the controller. In the figure, the permitting output voltage to the load (load1), is depicted in cases where the first switch and the second switch of leg 1 and leg 2, with regard to segment one, regulates ON/OFF.

Referring to the figure, the controller (410) regulates the turning on of the second switch (Sd1) connected to connection A2 and a load (load1) thereof, before a given time compared to the first switch (Su1), in cases where a first switch (Su1) connected to connection A1 and a load (load1) thereof, among a plurality of loads (load1, load2, load3, load4), is turning on. At this time, the second switch (Sd1) of leg 2 maintains the. TURN OFF state in response to the turning on of the second switch (Sd1), and the second switch (Sd1) of leg 1 maintains the TURN OFF state in response to the turning on of the second switch (Su1). In this case, leg 1 is the lagging leg with regard to leg 2, and leg 2 is the leading leg with regard to leg 1. Also, according to such cases, the controller can regulate the turning on of the second switch (Sd1) connected at a load and connected A2 thereof, after a given time compared to the first switch (Su1) in cases where the first switch (Su1) connected at a load and connection A1 thereof is turning on. In this case, leg 1 is the leading leg with regard to leg 2, and leg 2 is the lagging leg with regard to leg 1.

Preferably, the TURN ON time of each first switch (Su1, Su2, Su3, Su4, Su5) and the TURN ON time of each second switch (Sd1, Sd2, Sd3, Sd4, Sd5) could be the same, and the load moves one of the legs with regard to those connected at both ends from the opposite leg to the leading leg, and the opposite leg moves to the lagging leg.

The wave pattern of the output voltage to the load (load1) of segment one, in accordance with the ON/OFF action of the first switch (Su1, Su2) and the second switch (Sd1, Sd2) of leg 1 and leg 2, is as depicted.

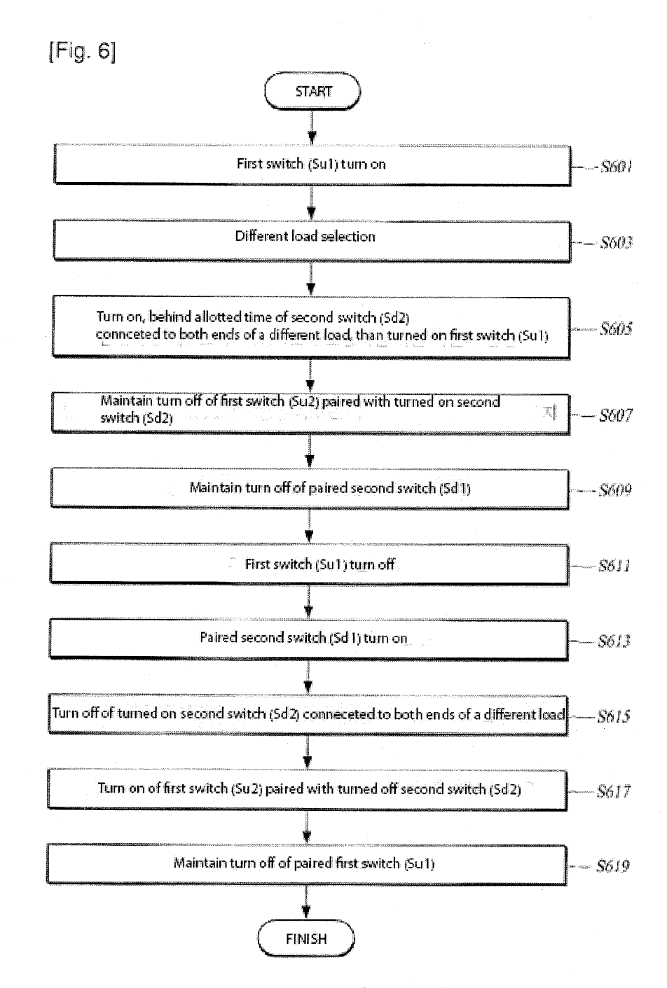

FIG. 6 roughly depicts the controlling method for the full bridge inverter, according to the preferred embodiment of the present invention. Referring to FIG. 2, FIG. 5 and FIG. 6, the method for controlling the full bridge inverter, according to the preferred embodiment of the present invention, is specifically explained.

Referring to the figures, the controller (410) selects a load in order to supply current, among a plurality of loads (load1, load2, load3, load4) connected between each segment (S601). Herein, referring to FIG. 2, which explains that the first load (load1) is selected, and all switches are initially hypothesized as in the TURN OFF state.

Once a load (load 1) is selected, in order to supply current the controller turns either the first switch (Su1, Su2) or the second switch (Sd1, Sd2) of the first leg and second leg that is connected standardly at both ends of the selected load thereof (load1), ON/OFF (S603).

Hereinafter, it is explained that leg 1 moves by way of the lagging leg with regard to leg 2, in the case where the controller (410) controls each of the switches. In order to move leg 1 by way of the lagging leg with regard to leg 2, the controller (410) turns on the second switch (Sd2) of leg 2 first. At this time, the turned-on second switch (Sd2) of leg 2 paired with the first switch (Su2) of leg 2 both maintains the TURN OFF state (S605). This is also is the case with the switches of leg 1 (Su1, Sd1). With the exception of the second switch (Sd1) of leg 2, as the remaining switches maintain the TURN OFF state there is no inflow of current via the load (load1).

Subsequently, the controller (410) turns on the first switch (Su1) that is connected to connection A1 of leg 1 thereof before the second switch (Sd2) after a given time (S607). The first switch (Su1) of leg 1 paired with the second switch (Sd1) both maintain the TURN OFF state while the first switch (Su1) of leg 1 maintains the TURN ON state (S609).

A passage route is formed of the first switch (Su1) of leg 1, the load (load1), and the second switch of leg 2 (Sd2) from the DC input voltage due to the TURN ON of the first switch (Su1) of leg 1.

Hereinafter, it is explained that in order for leg 1 to control the movement of the lagging leg with regard to leg 2, the second switch (Sd2) of leg 2 is turned on first, however, in order for leg 1 to control the movement of the leading leg with regard to leg 2, the second switch (Su1) of leg 1 could also be turned on first.

Next, the controller (410) turns on the first switch (Su2) of leg 2 paired with the turned off second switch (Sd2) (S613) and turns off the turned-on second switch (Sd2) of leg 2 (S611). At this time, the load (load1) permitting voltage across both ends is maintained due to the charged voltage to the capacitor of the second switch (Sd2) until the first switch (Su2) of leg 2 is turned on, even though the second switch (Sd2) of leg 2 is turned off. (Herein, it is supposed that the charging voltage of the capacitor is maintained once the second switch (Sd2) of leg 2 is turned off and until the first switch (Su2) of leg 2 is turned on). The output voltage if the first switch (Su2) of leg 2 is turned on, is equivalent across both ends of the load (load 1), as depicted. Here the explanation is that supposedly by way of pure resistance in each load (load1, load2, load3, load4) the charged voltage to the capacitor of each switch is maintained. However, generally if the second switch (Sd2) of leg 2 and/or the first switch (Su1) of leg 1 is turned off, the voltage of one side of the turned off switch (the second switch (Sd2) of leg 2 and/or the first switch (Su1) of leg 1) compared to the other may change due to the inductance comprised in each load (load1, load2, load3, load4).

Next, the first switch (Su1) of leg 1 that is connected to connection A1 of the load thereof (load1) is turned off (S615), and, the second switch (Sd1) that was maintained in the TURN OFF of leg 1 is turned on (S617). At this time, the load (load1) voltage across both ends is similarly maintained due to the charged voltage to the capacitor of the first switch (Su2) until the second switch (Sd2) of leg 1 is turned on, even though the first switch (Sd2) of leg 1 is turned off. Also, a passage is formed due to the first switch of leg 2 (Su2), the load (load1), and the second switch (Sd1) of leg 1, and if the second switch of (Sd1) of leg 1 is turned on, the DC permitting voltage of the opposite direction for the load is extended, as depicted in FIG. 5. At this time, the turned off first switch (Su1) of leg 1 is maintained in the TURN OFF state (S619) and, the DC permitting voltage of the opposite direction is maintained until the second switch (Sd2) of leg 2 in the TURN OFF state on both ends of the load (load1) is turned on.

In the following manner, the controller (410) selects a load in order to permit the voltage and by ON/OFF control of the above segments, the DC permitted voltage of the above load can become converted to alternating current voltage. At this time, the ON/OFF controlling switch of the above segment controls the selection of the load adequately, and it is not required to install a separate connective switch. Also, by increasing the number of semiconductor devices to 8, in order to supply current to 4 loads, since the total number of semiconductor devices is 10, the number of semiconductor devices as compared to traditional technology can be reduced.

Previously, In other words, more than one of the components from above can be combined selectively by movement, within the purpose of what is claimed of the present invention. Also, although each of the components can he distinguished as separate hardware; each of the components could be used in whole and/or part and be selectively combined in one and/or a plurality of hardware, and be realized as computer programs containing execution program modules. Code and code segments contained in such a computer program could be simply inferred in regard to those in the technological field of the present invention. The preferred embodiment of the present invention could be realized by reading Computer Readable Media stored on a computer running such a program. Computer Readable Media of the computer program could comprise personal storage media, fiber optic media, carrier wave media, etc.

Also, the specified terms including “Comprise,” “Contain,” and/or “Possess” etc., denote specifically the said components and should not be interpreted as other components than those mentioned, but as separate components, especially in cases where no opposing terms are specified, All of the terminologies that contain technical or scientific terms that are not herein defined shall have the same meaning as generally understood within the knowledge possessed by those in the technological field related to the present invention. With regard to the present invention, those cases that are not clearly defined shall not be interpreted with abnormal or exaggerated meanings, and the dictionary definition generally used in the terms shall be interpreted with a meaning relevant within the context of the technological field.

Accordingly, the applied cases explained above, in addition to the components outlined in the figures represent just the beginning of the preferred embodiment of the present invention, and do not represent the entire thoughts of the present inventors, and it must be understood at the time of submission that there may be various modifications or transformations. Similarly as above, since the disclosed preferred embodiment should not be restricted, those with a knowledge of the technological field of this patent can understand that the above is prone to various modifications and transformations within the scope of what is claimed in the present invention.

1. The full bridge inverter is comprised of:
a plurality of first switches connected at one end thereof to a positive terminal for a direct current (DC) input voltage;
a plurality of second switches connected at one end thereof to a negative terminal for said DC input voltage; and,
a plurality of loads connected at connection terminals formed by one-on-one connections of the opposite ends of each said first switch to the opposite ends of each said second switch.

2. According to claim 1,
regarding the full bridge inverter,
each said first switch and said second switch,
is comprised of a parallel-connected structure wherein each is formed with a transistor, diode and capacitor.

3. According to claim 1,
the full bridge inverter is further comprised of
an ON/OFF regulating controller with regard to each said first switch and each said second switch.

4. According to claim 3,
with regard to full bridge inverter
said controller,
has the characteristics wherein the said second switch connected directly to said turned-on first switch thereof, maintains the TURN OFF STATE, in the case wherein at least one first switch, among a plurality of said first switches maintains the TURN ON state.

5. According to claim 3,
with regard to full bridge inverter
said controller
has the characteristic wherein said first switch connected directly to said turned-on second switch thereof maintains the TURN OFF state, in cases where at least one second switch, among a plurality of said second switches, maintains the TURN ON state.

6. The full bridge inverter of claim 3,
said controller,
has the regulating characteristics wherein said second switch connected at both ends of said load thereof, before a given time, turns on; in cases where said first switch connected to one end of at least one load thereof among a plurality of said loads, maintains the TURN ON state.

7. The full bridge inverter of claim 3,
said controller,
of the full bridge inverter has the characteristic control of
turning on a second switch connected thereof at both ends of said load, after a given time, in cases where said first switch connected thereof at one end of a load, among a plurality of said loads is turned on.

8. The full bridge inverter of claim 3,
said controller,
of the full bridge inverter has the characteristic control of
turning on said second switch connected at one end of said load thereof, before a given time, in the case wherein said first switch connected to said second switch connected at both ends of said load thereof is turned on; and,
the turning on of said second switch connected at both ends of said load thereof, after a given time, in the case wherein said first switch connected thereof at one end of said load among a plurality of loads is turned on.

9. The full bridge converter is comprised of:
a plurality of first switches connected at one end to a positive terminal for a direct current (DC) input voltage;
a plurality of second switches connected at one end to a negative terminal for said DC input voltage; and a plurality of loads connected at connection terminals formed by one-on-one connections of the opposite ends of each first switch to the opposite ends of each second switch and accordingly,
the method for controlling the full bridge inverter is comprised of the following steps:
the step wherein at least one first switch, among a plurality of said first switches is turned on; and
the step wherein a said second switch connected directly to said turned off first switch maintains the TURN OFF state while said turned off first switch maintains the TURN ON state.

10. According to claim 9,
the method for controlling the full bridge inverter is further comprised of the following steps:
the step wherein the said turned-on first switch is turned off;
the step where at least one second switch among a plurality of said second switches is turned on; and
the step wherein said first switch, connected to said second switch maintains the TURN OFF state, while said turned-on second switch maintains the TURN ON state.

11. According to claim 9,
the method for controlling the full bridge inverter is further comprised of the step wherein,
the said second switch connected at both ends of the load thereof connected to one end of the said turned off first switch thereof among a plurality of said loads, is turned on after a given time compared to said turned-on first switch.

12. According to claim 9,
the method for controlling full bridge inverter is comprised of the step wherein,
said second switch connected at both ends of a load thereof connected at one end of a said turning off first switch, among a plurality of said loads is turned on before a given time compared to said turned-on first switch.

13. According to claim 9,
the method for controlling the full bridge inverter is comprised of the following steps:
the step wherein said second switch connected at both ends of the said load thereof connected at one end of the said turned-on first switch, from among a plurality of said loads; the step wherein said turned-on first switch is turned off;
the step wherein said turned-on second switch is turned off; and
the step wherein said first switch connected to said second switch is turned on.

14. According to claim 13,
the method for controlling the full bridge inverter is comprised of the step wherein,
the said second switch connected at one end of the said load is turned on before a given time compared to said turning on first switch.

15. According to claim 13,
the method for controlling the full bridge inverter is comprised of the following steps:
The step wherein a load is selected, in order to supply current; and the step wherein the second switch connected at both ends of the said selected load thereof is turned on before a given time compared to said turning on first switch, after the first switch connected at one end of the said selected load thereof is turned on.
